(19) United States
(12) Patent Application Publication
(10) Pub. No.: US 2007/0092857 A1
(43) Pub. Date: Apr. 26, 2007

(54) Method and apparatus for supporting training, and computer product

(75) Inventor: Yoshinobu Ito, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/261,789

(22) Filed: Oct. 31, 2005

(30) Foreign Application Priority Data
Jul. 20, 2005 (JP) 2005-210494

(51) Int. Cl. G09B 19/00

(52) U.S. Cl. 434/118

(57) ABSTRACT

An application that operates on a user terminal records an operation performed by a user, in an operation history data. A training support apparatus stores the operation history data in an operation history DB, and analyzes the operation history data to generate a use record DB. The training support apparatus generates a customized curriculum and advice data based on the use record DB, to provide efficient training according to a knowledge level and a usage pattern of the user.

### BACKGROUND OF THE INVENTION

1. Field of the Invention

The present invention relates to a technology for supporting training for using an application program.

2. Description of the Related Art

Many new functions are added to an application program (hereinafter, “application”) each time the application is updated to a new version. Such new functions contribute to the improvement in productivity only if the functions are effectively utilized by a user. If the functions are not effectively used, such functions become useless.

User training is one of measures to achieve effective use of the functions. By training users, for example, in the form of collective training or online training, the new functions are widely spread among the users to be effectively used.

However, since a knowledge level and a usage pattern of the application vary among users. Therefore, it is preferable that a training content is changeable depending on a level of a user. For example, in a technology disclosed in Japanese Patent Application Laid-Open No. 2003-140538, a test is provided to be taken by each user and a training curriculum is modified according to a result of the test.

In such method based on the test, however, it is difficult to precisely understand the knowledge level and the usage pattern of each user because there are limitations in work to be done for creating the test and time to be spent for conducting the test. Furthermore, there is a case in which such a user is undesirably excluded from a subject to be trained that has some knowledge about the functions but is not capable of using the functions.

### SUMMARY OF THE INVENTION

It is an object of the present invention to at least solve the problems in the conventional technology.

A computer-readable recording medium according to one aspect of the present invention stores therein a computer program for supporting training for using an application program. The computer program makes a computer execute analyzing a record of usage of functions in the application program based on an operation history of the application program; and generating data relating to the training based on a result of analysis at the analyzing.

An apparatus for supporting training for using an application program according to another aspect of the present invention includes an analyzing unit configured to analyze a record of usage of functions in the application program based on an operation history of the application program; and a generating unit configured to generate data relating to the training based on a result of analysis by the analyzing unit.

A method of supporting training for using an application program according to still another aspect of the present invention includes analyzing a record of usage of functions in the application program based on an operation history of the application program; and generating data relating to the training based on a result of analysis at the analyzing.

The other objects, features, and advantages of the present invention are specifically set forth in or will become apparent from the following detailed description of the invention when read in conjunction with the accompanying drawings.

The other objects, features, and advantages of the present invention are specifically set forth in or will become apparent from the following-detailed description of the invention when read in conjunction with the accompanying drawings.

### BRIEF DESCRIPTION OF THE DRAWINGS

FIG. 1 is a schematic for illustrating an overview of a training support system according to one embodiment of the present invention;

FIG. 2 is a block diagram of an application shown in FIG. 1;

FIG. 3 is a schematic for illustrating a data structure of operation history data;

FIG. 4 is a schematic for illustrating a data structure of advice data;

FIG. 5 is a block diagram of a training support apparatus shown in FIG. 1;

FIG. 6 is a schematic for illustrating a content to be output by a use-record output unit;

FIG. 7 is a schematic for illustrating a data structure of a user information database (DB);

FIG. 8 is a schematic for illustrating a data structure of a use record DB;

FIG. 9 is a schematic for illustrating a data structure of a training contents DB;

FIG. 10 is a flowchart of a process of the application of FIG. 2;

FIG. 11 is a flowchart of a process in a case in which a training content for a function that is used in low frequency based on a use record of a specific individual user;

FIG. 12 is a flowchart of a process in a case in which a training content for a function that is used in low frequency based on a use record of each division; and

FIG. 13 is a block diagram of a computer that executes a training support program.

### DETAILED DESCRIPTION OF THE PREFERRED EMBODIMENTS

Exemplary embodiments according to the present invention are explained in detail below with reference to the accompanying drawings. In the following embodiments, the case where a training support program and a training support apparatus are used to train users how to use a computer-aided-design (CAD) application is explained as an example. However, the training support program and the training support apparatus are also useful for training users for other types of application.

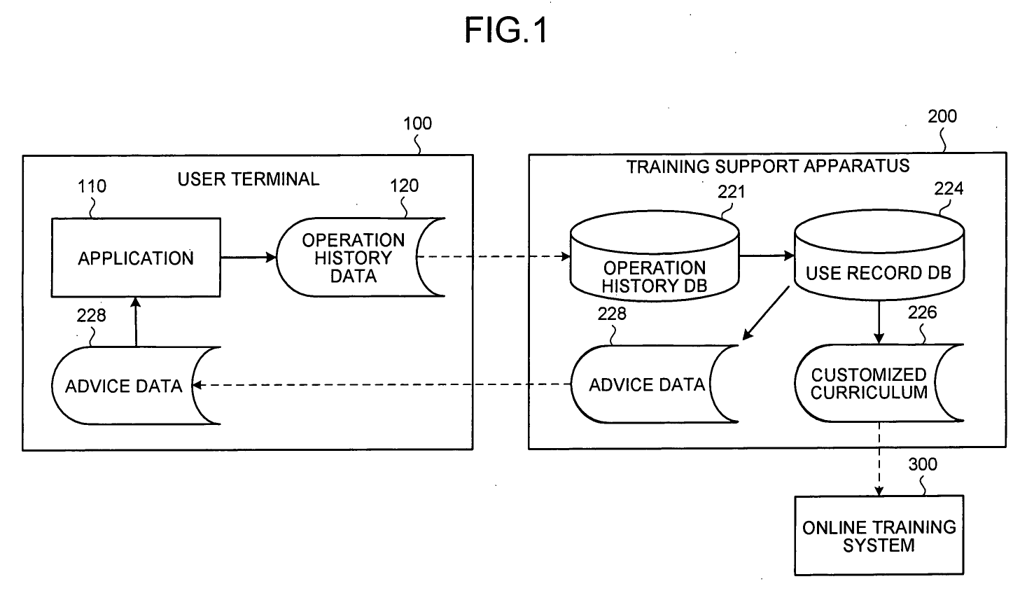

FIG. 1 is schematic for illustrating an overview of a training support system according to one embodiment of the present invention. In this training support system, an operation history of the application is recorded, the operation history is collected and analyzed to obtain a use record, and the content of training is determined based on the use record.

A user terminal 100 is an information processor used by a user of an application (hereinafter, “training target application”) for which training is provided. An application 110, which is the training target application, operates on the user terminal 100. The application 110 sequentially records the contents of operation by the user, as operation history data 120.

Although explanation is made based on the application 110 that is the CAD application in the following embodiments as an example, the present invention is also useful for other applications. Furthermore, the version of the application 110 may be the same as the version for which the training is provided, or may be one of old versions.

The operation history is not necessarily recorded by the application 110 itself, and may be recorded by another application by monitoring the application 110 from the outside.

The operation history data 120 recorded in the user terminal 100 is sent to a training support apparatus 200, and is merged with operation histories recorded in other user terminals, to be stored in an operation history DB 221. The training support apparatus 200 then analyzes the operation history DB 221 to create a use record DB 224.

The training support apparatus 200 generates training data such as a customized curriculum 226 and advice data 228 based on the use record DB 224. The training data is to be basic data for providing the training.

In the customized curriculum 226, contents of the training is defined. For example, in an online training system 300, the training item is selected based on the customized curriculum 226. The advice data 228 includes. data that is used when the application 110 proposes a more efficient function to a user.

In the training support system, the contents of the training is decided based on the use record generated from the operation history. Therefore, it is possible to provide efficient training that is suitable for a knowledge level and a usage pattern of each user.

Furthermore, in the training support system, the advice data is generated based on the use record, and a new function is presented to be introduced to a user based on the advice data while the use is using the application. Thus, the training can be provided during dairy operation. Therefore, it is possible to provide the training even to such users that are too busy to afford the time to attend the collective training. In such a method of introducing a new function, if many unnecessary functions are presented to the user, the productivity of the user can rather decrease. However, the training support system according to the embodiment has no such problems because the advice data is created based on the use record generated from the operation history.

The method of generating the training data based on the use record includes various modes, and the modes can be used depending on a purpose. One of the modes focuses on functions that are used in low frequently by a user. This mode is suitable when the application used by the user is of the same version as the version for which the training is to be provided or is an application having functions equivalent to functions of the training target application.

In this mode, the training is focused on functions that are not effectively used although the functions are ready to be used. The functions to be focused on are not only determined based on frequency, but also based on importance from the viewpoint of the user. Therefore, such a function that is not very important for the user is excluded from the training items even if the function is used in low frequency. Thus, it is possible to efficiently provide the training.

Another one of the modes focuses on functions that are used in high frequency by the user. This mode is suitable when the application used by the user is of a version earlier than the version for which the training is to be provided. In this mode, the training is focused on new functions related to the functions that have been used in high frequency by the user.

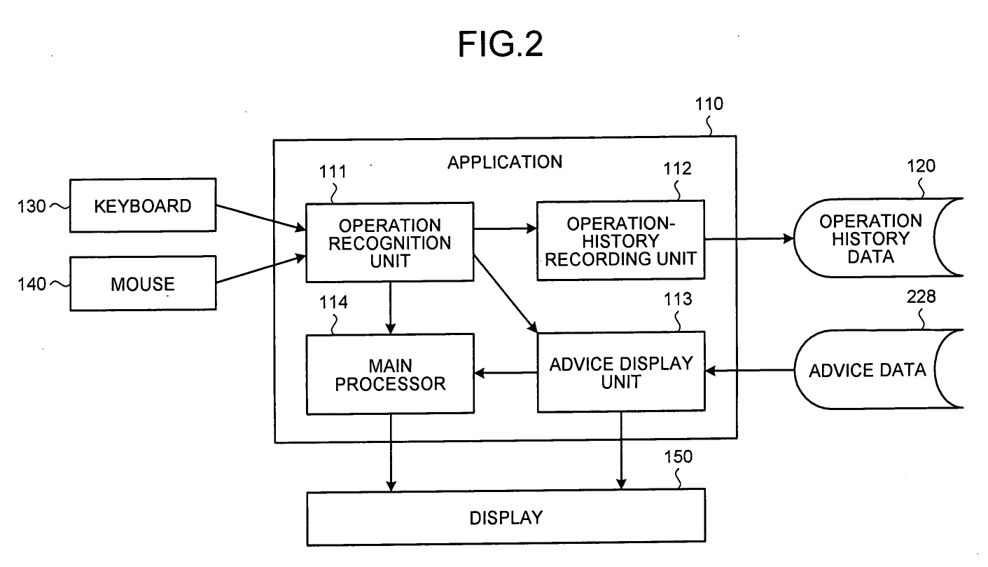

FIG. 2 is a block diagram of the application 110 shown in FIG. 1. The application 110 includes an operation recognition unit 111, an operation-history recording unit 112, an advice display unit 113, and a main processor 114.

The operation recognition unit 111 is recognizes an operation performed by a user using a keyboard 130 and a mouse 140. The operation-history recording unit 112 records the operation recognized in the operation history data 120.

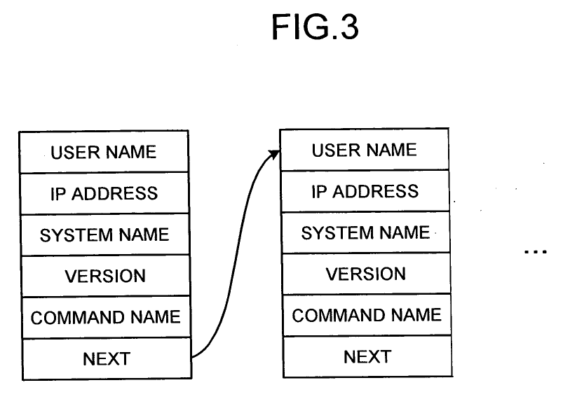

FIG. 3 is a schematic for illustrating a data structure of the operation history data 120. The operation history data 120 records, for each operation, a user name, an internet protocol (IP) address, a system name, a version, a command name, and time of use.

The user name indicates a name for identifying a user, and is set by acquiring a logon name used for user authentication. The IP address indicates a user terminal on which the application 110 operates. The system name and version indicate a name and a version of the application 110. The command name indicates a name of a process corresponding to an operation performed by the user. The time of use is a date and time when the operation is performed.

Although the overall data structure is expressed in a form of list in the embodiment, the data structure is not necessarily in the form of list, and hence, information may be held in another data structure such as a table.

Referring back to FIG. 2, the advice display unit 113 displays an advice corresponding to the operation recognized. The advice is determined based on the advice data 228.

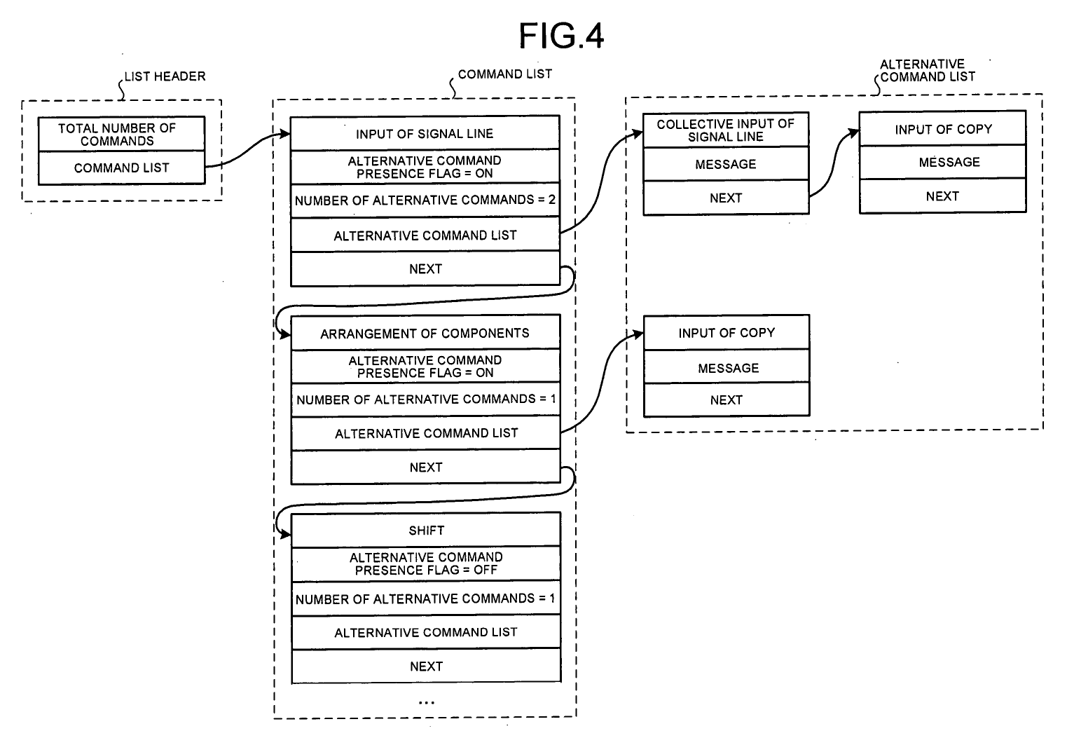

With an example of the advice data 228, a specific example of the advice to be displayed is explained below. FIG. 4 is a schematic for illustrating a data structure of the advice data 228. The advice data 228 includes three layers, such as a list header, a command list, and an alternative command list. The list header is data at the highest order of the three, and stores the number of commands included in the command list and a pointer for shifting to a header element of the command list.

The command list is a list including commands, as elements of the list, each of which is a process corresponding to an operation performed by the user. Each of the elements stores a command name, a flag, the number of alternative commands, and a pointer. The flag indicates whether there is an alternative command corresponding to a relevant command. The pointer is used to shift the process to an initial element of the alternative command list.

The alternative command list is a list including other commands, as elements of the list, each of which serves as a function equivalent to that of a relevant command, and is provided for each element of the command list. Each of the elements in the alternative command list stores a command name and a message for explaining a command.

When the user operates the application 110 so as to shift a design element, the operation recognition unit 111 recognizes that a “shift” command is executed, and informs the advice display unit 113 of execution of the “shift” command. The advice display unit 113 searches the command list to search for an element in which the command name is “shift”. In the element searched, since the flag is off, the advice is not displayed in this case.

When the user operates input of a signal line in the application 110, the operation recognition unit 111 recognizes that an “input of signal line” command is executed, and informs the advice display unit 113 of execution of the “input of signal line” command. The advice display unit 113 searches the command list to search for an element in which the command name is “input of signal line”.

In the element searched, since the flag is on, the advice display unit 113 acquires an alternative command list corresponding to the element according to the pointer, and displays the content of the alternative command list on a display 150. In this case, there are two alternative commands of “collective input of signal line” and “input of copy”. Therefore, these two commands are displayed together with their messages, to cause the user to select either one of execution of “input of signal line” as it is, and execution of “collective input of signal line” or “input of copy”.

When the version of the application is upgraded, in most cases, the application is improved such that equivalent functions are executed with a simpler operation than before, there by improving the productivity. By registering such a new operation with high productivity in the advice data 228 as its alternative command, the new operation can be provided to users according to the operation performed by the user. Thus, the new operation is understood by the user.

Referring back again to FIG. 2, the main processor 114 executes a process corresponding to an operation recognized in the operation recognition unit 111, and performs the functions of the application 110.

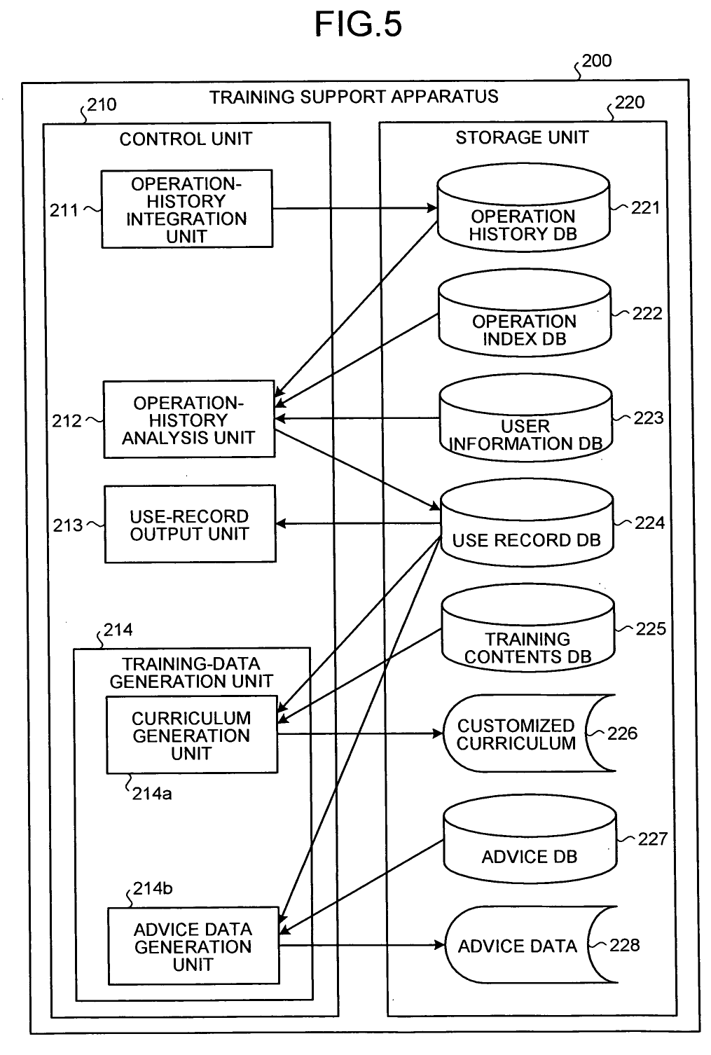

FIG. 5 is a block diagram of the training support apparatus 200 shown in FIG. 1. The training support apparatus 200 includes a control unit 210 and a storage unit 220.

The control unit 210 controls the whole of the training support apparatus 200, and includes an operation-history integration unit 211, an operation-history analysis unit 212, a use-record output unit 213, and a training-data generation unit 214. The operation-history integration unit 211 integrates the operation history data 120 recorded in each user terminal to store in the operation history DB 221.

The operation-history analysis unit 212 analyzes use records for the functions of the application 110, based on operation history information stored in the operation history DB 221, information related to an average operation frequency stored in an operation index DB 222, and attribute information for users stored in a user information DB 223, and stores results of analysis in the use record DB 224.

The use-record output unit 213 outputs the content of the use record DB 224 to a display unit and a printing unit, such as a display and a printer. By referring to the content output by the use-record output unit 213, a trainer can study what type of training is suitable.

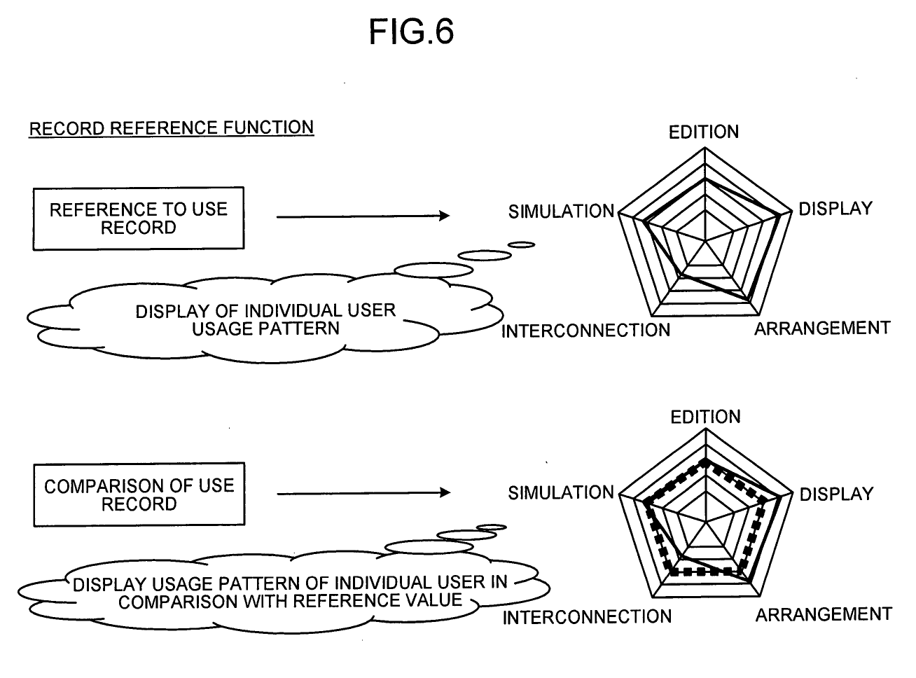

FIG. 6 is a schematic for illustrating a content to be output by the use-record output unit 213. The use-record output unit 213 outputs use patterns of the functions expressed in forms of graphs and tables. In the example shown in FIG. 6, the user use records are collected for each function type, and a collected result is compared with standard values to be displayed in the graph. In this graph, a comparison target can be changed to a value of another user or an average value of a specified group.

The training-data generation unit 214 generates data for performing training related to the application 110 based on the use record DB 224. The training-data generation unit 214 includes a curriculum generation unit 214a and an advice data generation unit 214b.

The curriculum generation unit 214a selects a training content included in a training contents DB 225, based on the use information stored in the use record DB 224, and generates the customized curriculum 226. The advice data generation unit 214b selects advice information included in an advice DB 227, based on the use information stored in the use record DB 224, and generates the advice data 228. Since the customized curriculum 226 and the advice data 228 are generated based on an actual use record of the user, the contents of the customized curriculum 226 and the advice data 228 become suitable for the knowledge level and the usage pattern of the user.

The storage unit 220 stores various data including the operation history DB 221, the operation index DB 222, the user information DB 223, the use record DB 224, the training contents DB 225, the customized curriculum 226, the advice DB 227, and the advice data 228.

The operation history DB 221 stores data in which operation histories recorded in user terminals are collected. The operation index DB 222 holds reference values indicating average use frequencies of the functions of the application.

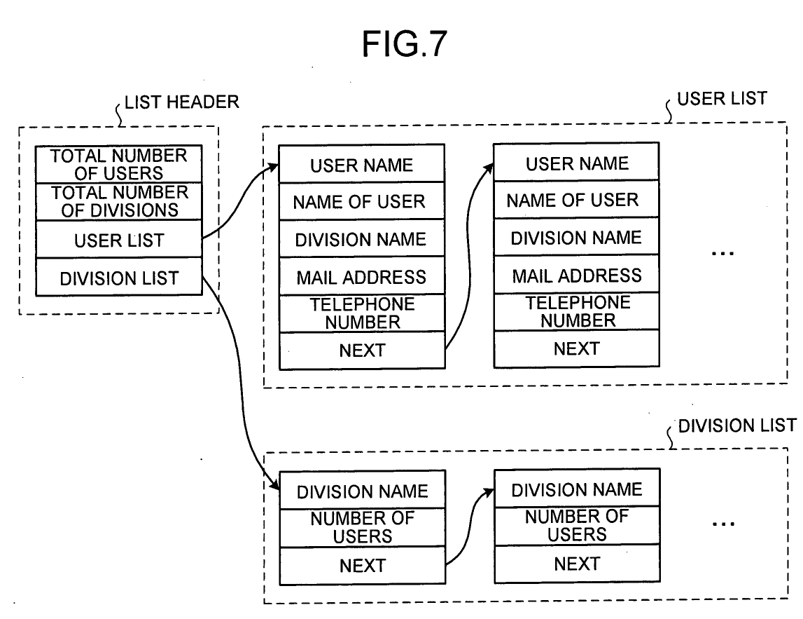

The user information DB 223 holds attribute information of users of the application. FIG. 7 is a schematic for illustrating a data structure of the user information DB 223.

The user information DB 223 includes a list header, a user list, and a division list. The list header stores the number of users included in the user list, the number of divisions included in the division list, a pointer for shifting to a header element in the user list, and a pointer for shifting to a header element in the division list.

The user list includes attribute information for users, as elements. Each of the elements includes a user name, a name of a user, a division name, a mail address, and a telephone number. The division list includes information on divisions to which users belong as elements. Each of the elements includes a division name, and the number of users that belong to the division.

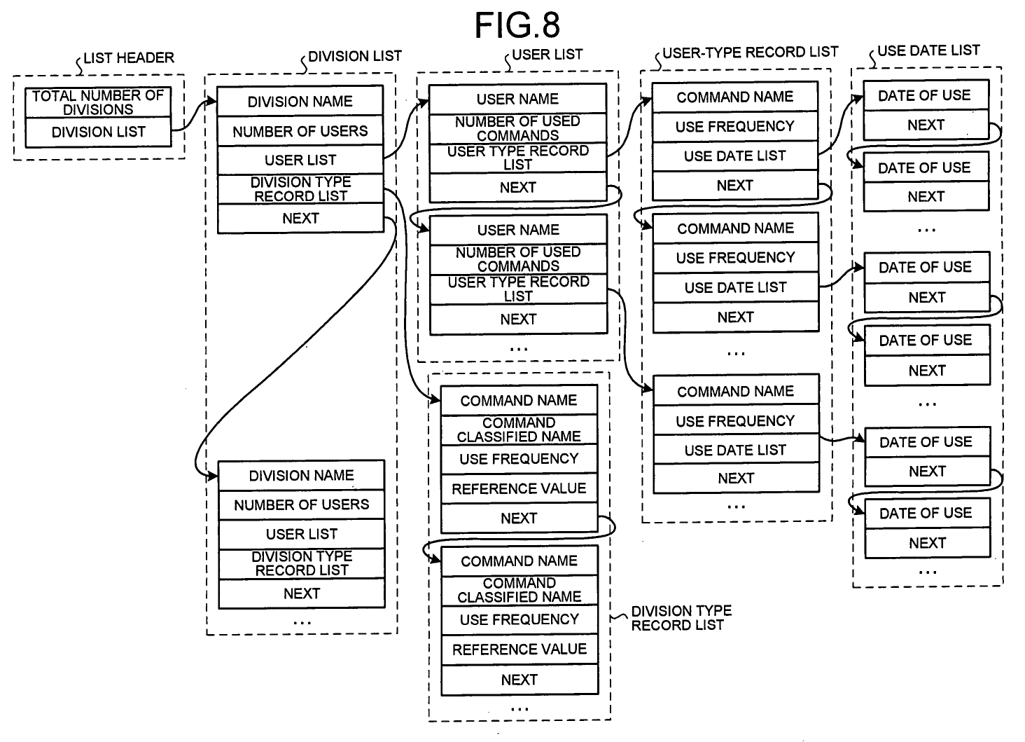

The use record DB 224 stores results obtained by analyzing the use records. FIG. 8 is a schematic for illustrating a data structure of the use record DB 224.

The use record DB 224 includes a list header, a division list, a user list, a use-type record list, a use date list, and division type record list. The list header stores the number of divisions included in the division list, and a pointer for shifting to a header element in the division list.

The division list is a list including user division information, as elements. Each of the elements includes a division name, the number of users that belong to the division, a pointer for shifting to an initial header element in the user list, and a pointer for shifting to an initial element in the division type record list.

The user list is a list including information for users belonging to respective divisions, as elements, and the list is provided for each element of the division list. Each of the elements includes a user name, the number of commands used by a relevant user, and a pointer for shifting to an initial element in the use-type record list.

The use-type record list includes a command used by a user and the frequency in which the command is used, as elements. The use-type record list is provided for each element in the user list. Each of the elements of the use-type record list includes a command name, a frequency in which a relevant command is used, and a pointer for shifting to an initial element in the use date list.

The use date list includes dates on which a command is used, as elements, and the use date list is provided for each element in the use-type record list. Each of the elements in the use date list includes dates on which the command is used.

The division type record list includes a command used by a user that belong to a division and a collected value of frequencies in which the command is used, as elements. The division type record list is provided for each element in the division list. Each of the division type record list includes a command name, a command classified name, a collected value of frequencies in which a relevant command is used by a user that belongs to a division, and a reference value indicating an average frequency in which the command is used (a value obtained based on the operation index DB 222).

The use record DB 224 stores the results of collecting the use records of the commands by division, as the analysis result. It is noted that this is only an example, and hence, other analysis results may be stored in the use record DB 224 according to the purpose of use.

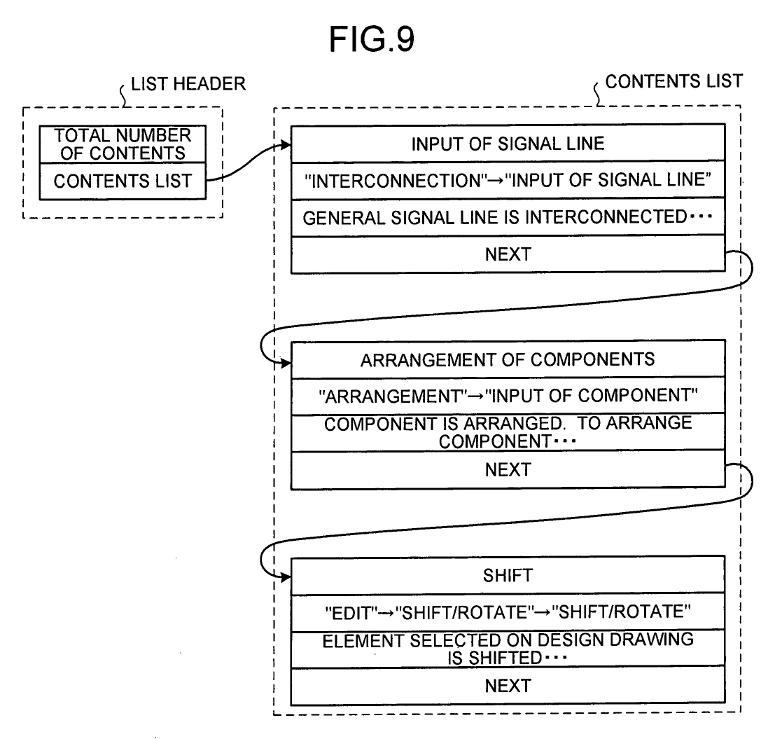

The training contents DB 225 stores contents of user training. FIG. 9 is a schematic for illustrating a data structure of the training contents DB 225.

The training contents DB 225 includes a list header and a contents list. The list header includes the number of contents included in the contents list, and a pointer for shifting to a header element of the contents list. The contents list includes a training content in each command, as elements. Each of the elements includes a command name, an operation procedure, and a message for explanation.

The customized curriculum 226 includes a training content extracted by the curriculum generation unit 214a from the training contents DB 225, based on the use record DB 224.

The advice DB 227 stores information for commands and alternative commands corresponding to the respective commands, and has the same structure as the advice data 228 shown in FIG. 4.

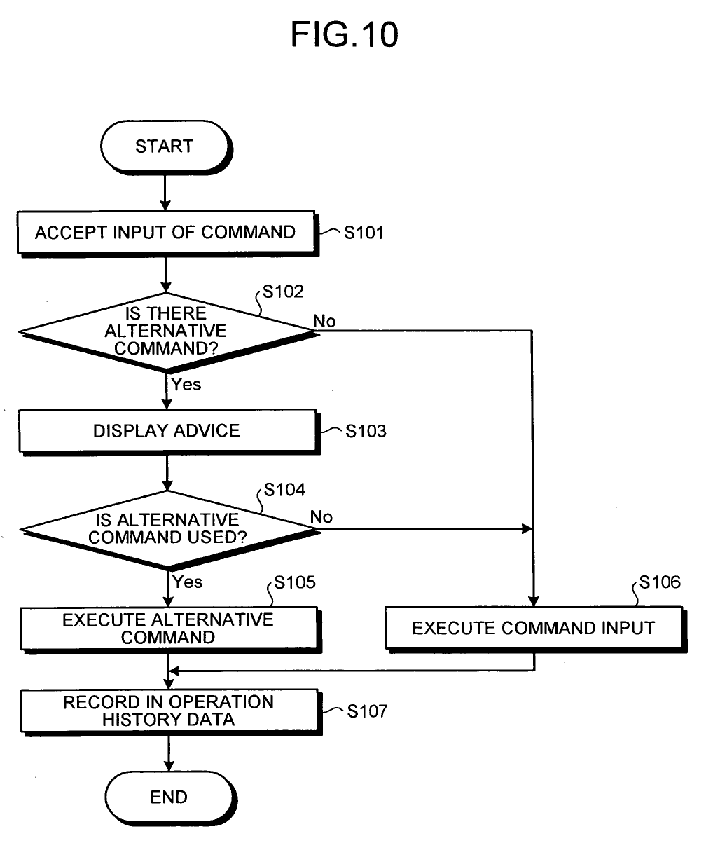

FIG. 10 is a flowchart of a process of the application 110. When accepting an input of a command through a keyboard (step S101), the application 110 refers to the advice data 228 to check whether there is any alternative command.

If there is an alternative command (“YES” at step S102), the application 110 displays the alternative command as an advice, and inquires a user about a command to be used by making the user select either of the command input by the user and the alternative command (step S103).

If the user selects the alternative command (step S104), the application 110 executes the alternative command (step S105). If the user selects the command input by the user (“NO” at step S104), or if there is no alternative command (“NO” at step S102), the application 110 executes the command input by the user (step S106).

When execution of the command is complete in the above manner, the application 110 records executed command in the operation history data 120 (step S107), and waits for an input of a next command.

The process performed by the training support apparatus 200 changes according to the purpose. As explained previously, the process varies depending on whether the operation history data 120 is the operation history generated as the execution result of an application of the same version as the version for which the training is provided. More specifically, if it is the operation history of the application of the same version, it is necessary to extract a training content for a function that has been used in low frequency. If it is the operation history of the application of an earlier version, it is necessary to extract a training content for a function that has been used in high frequency.

The process also varies depending on whether the training content is extracted based on the use record of a specified user, or the training content is extracted based on the use record of each division. The former is useful for online training or the like in which training is provided on the individual base, while the latter is useful for collective training provided on the division base.

When a new staff is assigned to a division, it is effective to extract a function that is used in high frequency based on the use record of the division. This is because an important function for the business related to the division can be set as a training item.

Although the users are grouped in each division in the embodiment, grouping may be performed in another unit. Further, it may be configured such that grouping is performed in plural layers, and that training data is analyzed and generated in each layer.

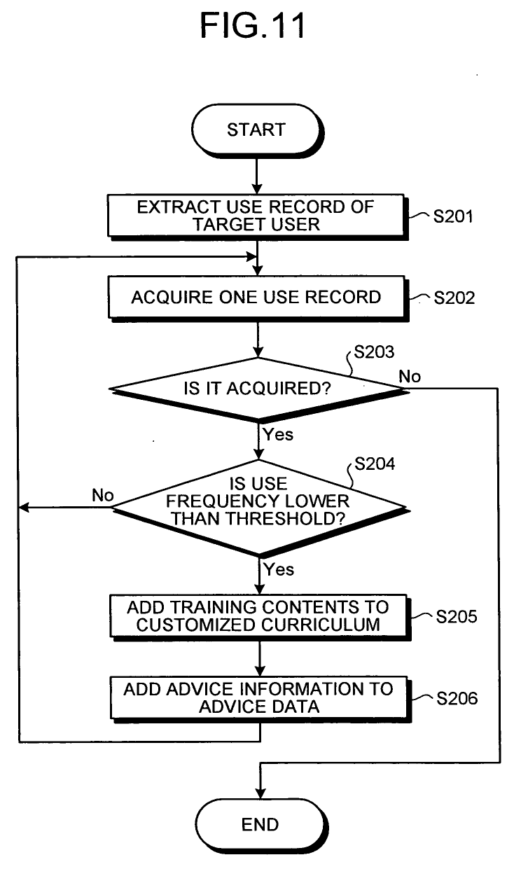

FIG. 11 is a flowchart of the process when a training content for a function that is used in low frequency is extracted based on the use record of a specific individual user. The training support apparatus 200 extracts a use record of a target user from the use record DB 224 (step S201).

The training support apparatus 200 acquires one piece of use record data that has not been processed yet (step S202). If it is acquired (“YES” at step S203), it is checked whether the use frequency is lower than a predetermined frequency. The predetermined frequency may be a fixed value specified by a trainer, or may be an average operation time or an average value of each division.

If the use frequency is lower than the predetermined frequency (“YES” at step S204), the training support apparatus 200 acquires a training content related to a command corresponding to the use record, from the training contents DB 225, and outputs the training content to the customized curriculum 226 (step S205). Similarly, the training support apparatus 200 acquires advice information from the advice DB 227, and outputs the advice information to the advice data 228 (step S206).

The processes from step S202 to step S206 are repeated until all the use records extracted at step S201 are processed.

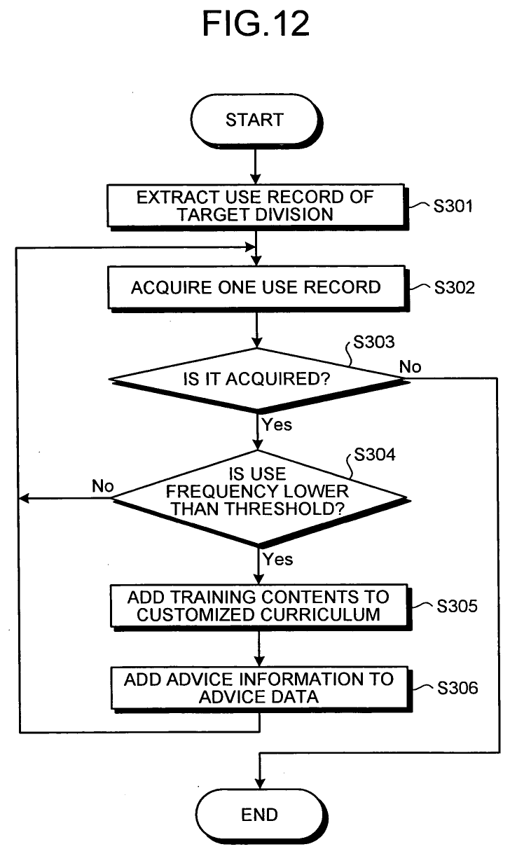

FIG. 12 is a flowchart of the process when a training content for a function that is used in low frequency is extracted based on a use record of each division. The training support apparatus 200 extracts a use record of a target division from the use record DB 224 (step S301).

The training support apparatus 200 acquires one piece of use record data that has not been processed yet (step S302). If it is acquired (“YES” at step S303), it is checked whether the use frequency is lower than a reference value. If the use frequency is lower than the reference value (“YES” at step S304), the training support apparatus 200 acquires a training content related to a command corresponding to the use record, from the training contents DB 225, and outputs the training content to the customized curriculum 226 (step S305). Similarly, the training support apparatus 200 acquires advice information from the advice DB 227, and outputs the advice information to the advice data 228 (step S306).

The processes from step S302 to step S306 are repeated until all the use records extracted at step S301 are processed.

The processes of the training support apparatus 200 explained in the embodiment can be performed by a computer executing a training support program that is prepared in advance.

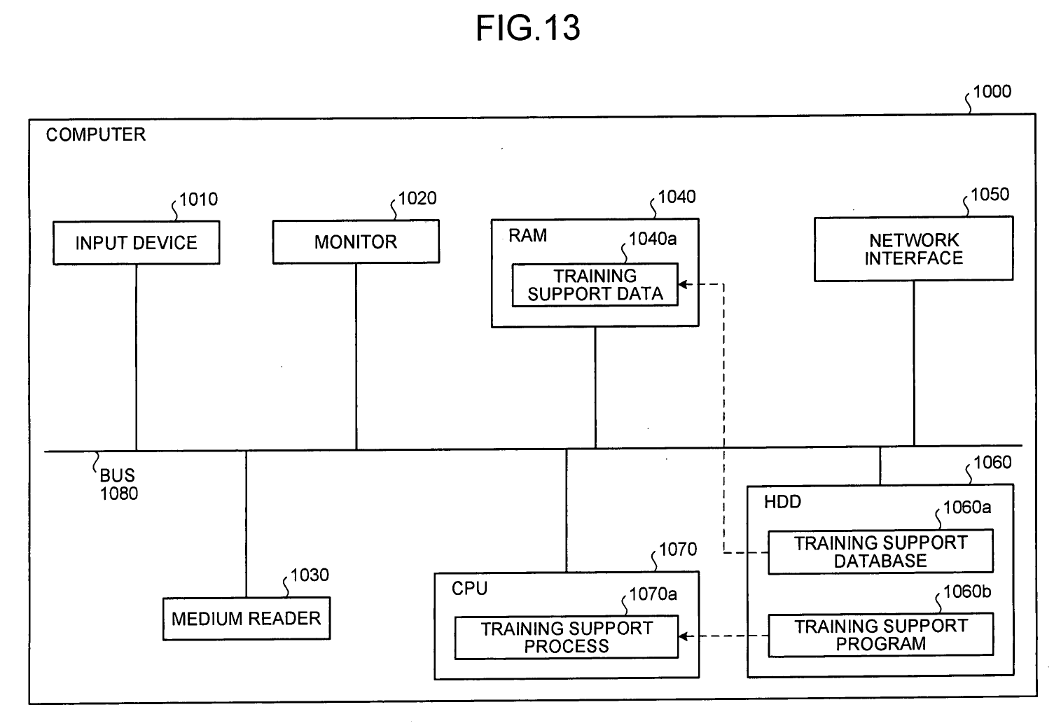

FIG. 13 is a block diagram of a computer that executes the training support program. A computer 1000 includes an input device 1010 that accepts an input of data from a user, a monitor 1020, a medium reader 1030 that reads a program from a recording medium with programs recorded thereon, a random access memory (RAM) 1040 that temporarily stores various pieces of information, a network interface 1050 that exchanges data with another computer through a network, a hard disk drive (HDD) 1060, and a central processing unit (CPU) 1070, that are connected through a bus 1080.

The HDD 1060 stores a training support program 1060b that realizes the same function as the function of the training support apparatus 200. The HDD 1060 also stores a training support database 1060a corresponding to those from the operation history DB 221 to the advice data 228 shown in FIG. 5.

The training support database 1060a may be arranged in an integrated manner or in a distributed manner as required.

The CPU 1070 reads the training support program 1060b from the HDD 1060 and executes it. The training support program 1060b thereby functions as a training support process 1070a. The training support process 1070a corresponds to the control unit 210 shown in FIG. 5.

The CPU 1070 reads required information from the training support database 1060a as necessary, stores the information in the RAM 1040 as training support data 1040a, and executes various data processes based on the training support data 1040a in the RAM 1040.

The training support program 1060b is not necessarily stored in the HDD 1060, and therefore, the computer may read the training support program 1060b from the recording medium such as compact-disk read-only-memory (CD-ROM) and executes it. Furthermore, the training support program 1060b is stored in another computer (or a server) connected to the computer 1000 through a public line, the Internet, a local area network (LAN), or a wide area network (WAN), and the computer 1000 may read this program from the another computer and execute it.

According to the embodiments described above, it is possible to provide efficient training for an application program according to a knowledge level and a usage pattern of a user.

Furthermore, according to the embodiments described above, it is possible to efficiently propose a function related to an operation performed by a user in an application program according to a knowledge level and a usage pattern of the user.

Moreover, according to the embodiments described above, it is possible to provide a reference for a trainer so that efficient training is provided based on the reference.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores therein a computer program for supporting training for using an application program, the computer program making a computer execute:
analyzing a record of usage of functions in the application program based on an operation history of the application program; and
generating data relating to the training based on a result of analysis at the analyzing.

2. The computer-readable recording medium according to claim 1, wherein the data includes a curriculum of the training.

3. The computer-readable recording medium according to claim 1, wherein
the data includes advice data for proposing an alternative function to a user, and
the generating includes generating the advice data, when one of operations of the application program is performed by the user, the advice data that includes the alternative function related to a performed operation.

4. The computer-readable recording medium according to claim 1, wherein the generating includes generating the data based on a record of usage of an individual user.

5. The computer-readable recording medium according to claim 1, wherein the generating includes generating the data based on a record of usage of a group of users.

6. The computer-readable recording medium according to claim 1, wherein the computer program further makes the computer execute outputting a result of analysis at the analyzing to an output unit.

7. An apparatus for supporting training for using an application program, comprising:
an analyzing unit configured to analyze a record of usage of functions in the application program based on an operation history of the application program; and
a generating unit configured to generate data relating to the training based on a result of analysis by the analyzing unit.

8. The apparatus according to claim 7, wherein the data includes a curriculum of the training.

9. The apparatus according to claim 7, wherein
the data includes advice data for proposing an alternative function to a user, and
the generating unit is configured to generate the advice data, when one of operations of the application program is performed by the user, the advice data that includes the alternative function related to a performed operation.

10. The apparatus according to claim 7, wherein the generating unit is configured to generate the data based on a record of usage of an individual user.

11. The apparatus according to claim 7, wherein the generating unit is configured to generate the data based on a record of usage of a group of users.

12. The apparatus according to claim 7, further comprising a result output unit configured to output a result of analysis by the analyzing unit to an output unit.

13. A method of supporting training for using an application program, comprising:
analyzing a record of usage of functions in the application program based on an operation history of the application program; and
generating data relating to the training based on a result of analysis at the analyzing.

14. The method according to claim 13, wherein the data includes a curriculum of the training.

15. The method according to claim 13, wherein
the data includes advice data for proposing an alternative function to a user, and
the generating includes generating the advice data, when one of operations of the application program is performed by the user, the advice data that includes the alternative function related to a performed operation.

16. The method according to claim 13, wherein the generating includes generating the data based on a record of usage of an individual user.

17. The method according to claim 13, wherein the generating includes generating the data based on a record of usage of a group of users.

18. The method according to claim 13, further comprising outputting a result of analysis at the analyzing to an output unit.
